(19) United States
(12) Patent Application Publication
(10) Pub. No.: US 2020/0320880 A1
(43) Pub. Date: Oct. 8, 2020

(54) INTELLIGENT VEHICLE BLIND SPOT DETECTION SYSTEM

(71) Applicants: FU DING PRECISION COMPONENT (SHEN ZHEN) CO., LTD., Shenzhen (CN); FOXCONN INTERCONNECT TECHNOLOGY LIMITED, Grand Cayman (KY)

(72) Inventor: CHUNG-NAN KO, New Taipei (TW)

(21) Appl. No.: 16/839,080

(22) Filed: Apr. 3, 2020

(30) Foreign Application Priority Data
Apr. 4, 2019 (CN) 201910268701.6

(51) Int. Cl. G08G 1/16; B60Q 9/00; B60R 11/02; B60R 1/12

(52) U.S. Cl. CPC G08G 1/167; B60Q 9/008; B60R 2011/0022; B60R 1/12; B60R 2001/1223; B60R 11/02

(57) ABSTRACT

An intelligent vehicle blind spot detection system, includes an MCU (microcontroller unit), visual detectors, a blind spot detection device and a warning device. The visual detectors are used to monitor whether the driver's eyesight directs to the left or right rearview mirror, and can be set on either side A-pillar or on the central control panel. The blind spot detection device is used to detect whether there are other vehicles in the blind zone of the driver's sight through the corresponding rearview mirror. The warning signal occurs only in a situation that both the visual detectors and the blind spot detection device obtain the respective positive results.

### BACKGROUND OF THE INVENTION

### 1. Field of the Invention

The present invention relates generally to an intelligent vehicle blind spot detention system, and particularly to the warning notice derived from the vehicle blind spot detection system is filtered via an eyesight detection system.

### 2. Description of Related Arts

Essentially, there are two kinds of startup mechanism of the blind spot detention system on the market. The first type requires the driver to manually activate such a system by switching the direction light pole. Notably, when the driver ignores or forgets to operate the direction light pole, such a detection system will not work, thus resulting in a potentially dangerous situation for the driver. The second type requires the system automatically and continuously operates even if the driver drives straight without intentions to make the lane change or the right/left turn. Notably, the warning notice provided by the alarming beep under such a situation is unwelcome.

Hence, an intelligent blind spot detention which only alerts the driver when the driver intends to make the lane change or the direction change, is desired.

### SUMMARY OF THE INVENTION

The invention related to an intelligent vehicle blind spot detection system, includes an MCU (microcontroller unit), visual detectors, a blind spot detection device and a warning device. The MCU can connect with the driving computer through the CAN BUS (Controller Area Network) to receive the real time traffic information, including the navigation, speed, steering wheel, the throttle and brake actuation, ON/OFF status of the lights, and the ADAS (Advanced Driver-Assistance System) related systems, etc. The visual detectors are used to monitor whether the driver's eyesight directs to the left or right rearview mirror, and can be set on either side A-pillar or on the central control panel. The blind spot detection device is used to detect whether there are other vehicles in the blind region of the driver's sight through the corresponding rearview mirror. The blind spot detection device can use the radar wave, camera head or infrared technology to detect the objects. The blind spot detection device can be set on the rearview mirror or appropriate positions of the car body. The light warning of the warning device can be set on the A-pillar or the rearview mirror within the car, as well as the warning sound to remind the driver of other vehicles in the blind area before the driver rotates the steering wheel.

Other advantages and novel features of the invention will become more apparent from the following detailed description of the present embodiment when taken in conjunction with the accompanying drawings.

### BRIEF DESCRIPTION OF THE DRAWING

FIG. 1 is a diagram of the intelligent vehicle blind spot detection system of the invention.

FIG. 2 is a diagram showing the operation process performed by the blind spot detection system of FIG. 1.

### DETAILED DESCRIPTION OF THE PREFERRED EMBODIMENT

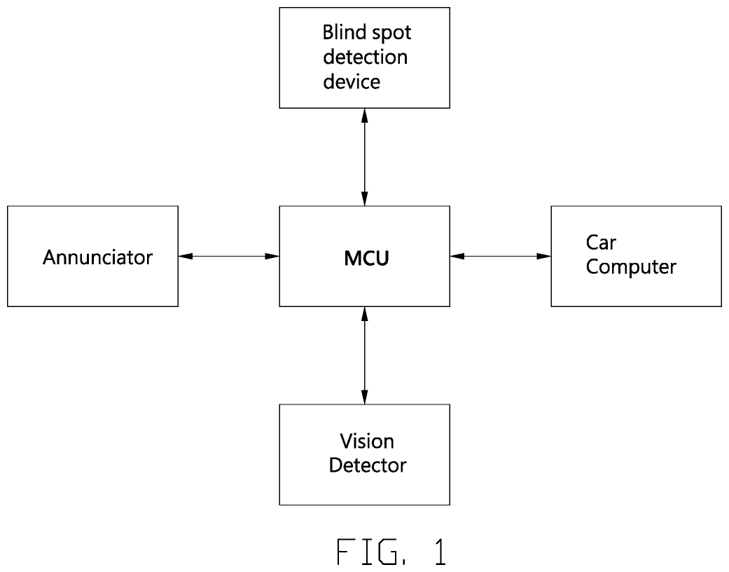

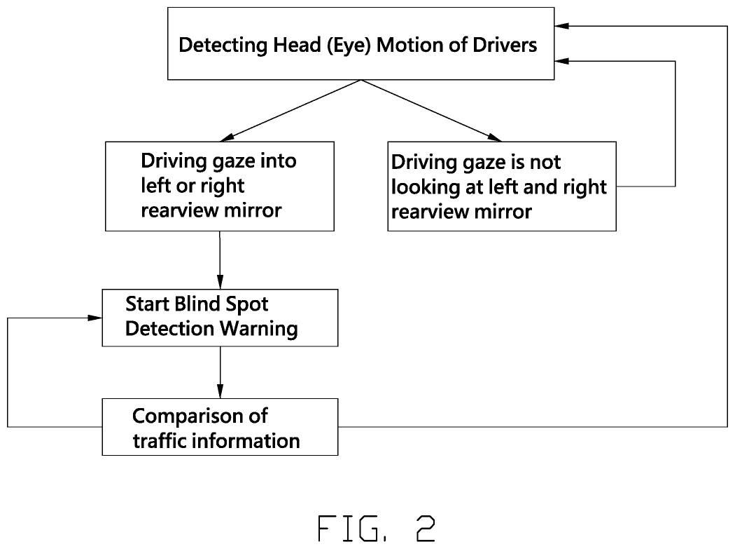

Referring to FIGS. 1 and 2, the intelligent vehicle blind spot detection system is built within a car, includes a controlling device connected with the MCU, a visual detector, a set of blind spot detectors and a warning device. Through the visual detector and the blind spot detectors, the driving status may be monitored for performing the intelligent driving. The set of visual detectors can be set at either side A-pillar or the central control panel in the car to catch the eyesight of the driver to verify whether the driver does really take a look the rearview mirror. The blind spot detector could use the radar wave, the camera or the infrared for detection, and could be located at the rearview mirror or the car tail to verify whether other cars or foreign items exist in the driving blind zone. Via cooperation of the visual detectors and the blind spot detectors, the warning notice, either via light or via sound, is activated to remind the driver of the existence of other cars.

Practically, the visual detectors mainly check the movement of the eye balls of the driver to check whether the eyesight is directed toward the rearview mirrors on two sides of the car. The warning notice only occurs when both the driver looks at the rearview mirror(s) and other vehicles exist in the blind zone. In the invention, the blind spot detectors could be activated only after the visual detector verifies the driver's intention; alternately, the blind spot detectors constantly work while the warning notice is only issued when both the two factors, i.e., the driver's intention to change lane or make a turn and existence of other vehicles in the blind spot zone, are satisfied.

The control system may collect driving information, including operations of the navigation, the speed, the steering wheel, the gas and the brake, and the ON/OFF status of the light, the ADAS, and the related system. The front panel may show such information. The blind spot detection system may be connected to a mobile device or a center controller for activation or deactivation. Through the detailed driving information, the factors verified by the blind spot detection system may determine ending of the changing lane if the direction light pole is back to the neutral position and the brake value is zero. If the car is equipped with the lane deviation detection system, a data from that system may be used as a reference to precisely determine ending of changing lane. If confirmed, the blind spot detection system may change from the warning status to the visual detection status. In other words, if the referencing driving data from other systems can not meet the required values of a stable straight driving manner, the warning signals may continue. An annunciator may be connected to the MCU for reflecting the status. Other operation variations may include showing the warning symbol quietly on the front panel or on the rearview mirror as long as the blind spot detectors verify other vehicles are located at the blind zone of the corresponding rearview mirror, disregarding whether the driver take a look at the rearview mirror, while the warning sound occurs only in response to a positive verification resulting from the set of the visual detectors,

In conclusion, the blind spot detectors are activated only after the visual detectors verifies the driver's intentions to change lane or make a right/left turn, and the warning signal is issued only after other cars or foreign items are verified by the blind spot detectors successively. Alternately, the blind spot detectors are constantly operated while the warning notice is issued only when both the two factors regarding the visual detectors confirms the driver's intention to change lane or make turn and the existence of the other cars or foreign items exist in the blind spot zone are satisfied.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An intelligent vehicle blind spot detection system for use within a vehicle, comprising:
a set of visual detectors for verifying whether a driver take a look at either side rearview mirrors of the vehicle; and
a set of blind spot detectors for verifying whether other vehicles exist in a blind zone of said vehicle in compliance with the corresponding side rearview mirror; wherein
a warning device performs a warning notice when verifications of both the visual detectors and the blind spot detectors are positive.

2. The intelligent vehicle blind spot detection system as claimed in claim 1, wherein the blind spot detectors are not activated when the verification of the visual detector is not positive.

3. The intelligent vehicle blind spot detection system as claimed in claim 1, wherein the visual detectors are located at either an A-pillar or a control panel in the vehicle.

4. The intelligent vehicle blind spot detection system as claimed in claim 1, wherein the blink spot detectors are located at the side rearview mirrors or a tail of the vehicle.

5. The intelligent vehicle blind spot detection system as claimed in claim 1, wherein the warning notice is a mark displayed on a panel, an A-pillar or on the rearview mirror.

6. The intelligent vehicle spot detection system as claimed in claim 1, wherein the warning notice is a sound in the vehicle.

7. A method of make warning in a vehicle, comprising steps of:
providing an MCU (microcontroller unit);
providing a set of visual detectors connected to the MCU;
providing a set of blind spot detectors connected to the MCU;
via said set of visual detectors, verifying whether a driver of said vehicle looks at a corresponding rearview mirror;
via said set of blind spot detectors, verifying whether other vehicles are located at a blind zone of said corresponding rearview mirror if the driver of said vehicle does loot at the corresponding rearview mirror according to the set of the blind spot detectors; and
sending a warning signal to the driver if both the driver of said vehicle does look at the corresponding rearview mirror and other vehicles are really located at the blind zone of said corresponding rearview mirror according to the set of blind spot detectors.

8. The method as claimed in claim 7, wherein the set of blind spot detectors is activated only after the set of visual detectors verifies the driver of said vehicle looks at the rearview mirror.

9. The method as claimed in claim 8, wherein the warning signal is a sound.

10. The method as claimed in claim 7, wherein both the set of blind spot detectors and the set of visual detectors are constantly in operation.

11. The method as claimed in claim 10, wherein the warning signal is a mark on a panel or on the rearview mirror.
